(19) United States
(12) Patent Application Publication
(10) Pub. No.: US 2025/0074773 A1
(43) Pub. Date: Mar. 6, 2025

(54) FERRIC PHOSPHATE, PREPARATION METHOD THEREOF, AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Cunpeng Qin, Foshan, Guangdong (CN); Changdong Li, Foshan, Guangdong (CN); Dingshan Ruan, Foshan, Guangdong (CN); Shenghe Tang, Foshan, Guangdong (CN); Zhenshuan Shi, Foshan, Guangdong (CN); Ling Li, Foshan, Guangdong (CN); Lei Yin, Foshan, Guangdong (CN)

(21) Appl. No.: 18/580,633

(22) PCT Filed: Jun. 6, 2022
(86) PCT No.: PCT/CN2022/097185

§ 371 Date: Jan. 19, 2024

(30) Foreign Application Priority Data
Jul. 19, 2021 (CN) 202110815191.7

(51) Int. Cl. C01B 25/37; C01B 25/45

(52) U.S. Cl. CPC C01B 25/375; C01B 25/451; C01P 2002/72; C01P 2004/03; C01P 2004/61; C01P 2006/11; C01P 2006/12; C01P 2006/40; C01P 2006/80

(57) ABSTRACT

The present application discloses a method for preparing ferric phosphate, including the following steps: mixing a surfactant with a first metal liquid containing iron and phosphorus elements, adding with adding seed crystal, aging under heating and stirring, filtering the aged solution to obtain a filter residue, and drying and sintering the filter residue, thereby obtaining the ferric phosphate; the seed crystal is ferric phosphate dihydrate or basic ammonium ferric phosphate. In the present application, the surfactant is used for modification of the seed crystal, secondary crystal nucleus is generated, which induces the formation of the basic framework of the product particles. Through the aging process, the deposition of the crystal nucleus on the surface of the seed crystal makes the framework of the crystal grain more complete, so that the primary particles are arranged more densely and orderly and tend to constitute spherical secondary particles.

### TECHNICAL FIELD

The present invention belongs to the field of battery materials, and specifically relates to ferric phosphate, a preparation method therefor, and use thereof.

### BACKGROUND

Lithium iron phosphate batteries are widely used by lithium battery production companies because of their low cost, low toxicity, high safety, long cycle life, and containing no rare elements such as Ni and Co. The precursor for preparing lithium iron phosphate cathode materials is ferric phosphate, whose quality would have a direct impact on the performance of lithium iron phosphate batteries. In current technology, ferrous salt is mainly used as the iron source for forming ferric phosphate, and an oxidizing agent such as hydrogen peroxide is added to oxidize the divalent iron ions into the trivalent iron ions. The oxidization consumes a large amount of hydrogen peroxide as the oxidizing agent, resulting in increased cost and lowered benefits compared to materials such as ternary materials. In the current technology in the market, ferric phosphate dihydrate is mostly prepared by a two-step co-precipitation method adopting aqueous ammonia and NaOH as an alkaline solution and adopting phosphoric acid as an aging agent. The slurry prepared by this method has high viscosity and poor batch stability. The massive use of the alkaline solution increases production cost and tends to increase the difficulty of water treatment.

Battery-grade ferric phosphate contains fewer impurities and has stable quality, and the lithium iron phosphate battery synthesized therefrom has stable performance and high capacity. The skeletal effect of the battery-grade iron phosphate on performance of lithium iron phosphate is more apparent: Lithium iron phosphate synthesized from ceramic-grade or food-grade ferric phosphate has a low capacity, and these ferric phosphates are only raw materials suitable for production of high-grade ceramics or nutritional supplements. The main problems facing the preparation of ferric phosphate are as follows: 1. Preparing ferric phosphate from a divalent iron source has to consume an oxidizing agent, cannot guarantee the uniformity of oxidation and oxidation time, and increases the production cost. 2. Small grain-sized ferric phosphate contains SO₄²⁻ that is difficult to be washed out, is easy to aggregate, and requires multiple times of wash for preparing products with qualified purity. 3. The batch stability is poor, and physical and chemical features have great fluctuation in batches as the intermittence method is commonly adopted in the market, leading to unguaranteed batch stability. Therefore, there is an urgent need to develop a method for preparing ferric phosphate with low cost and no aggregation, whose impurity is easy to be washed out, not only achieving economic benefits for the companies but also protecting the environment.

### SUMMARY

The present invention aims to solve at least one of the above-mentioned technical problems existing in the prior art. Accordingly, the present invention provides ferric phosphate, a preparation method therefor, and use thereof. The anhydrous ferric phosphate prepared in the present invention is spherical particles with controllable and uniformly distributed particle size, high tap density, and controllable crystal type and morphology, and can be used as a precursor material of lithium iron phosphate with high-compactness, and also has good application prospects in ceramics and catalysts.

According to one aspect of the present invention, a method for preparing ferric phosphate is provided, comprising the following steps:
mixing a surfactant with a first metal liquid containing iron and phosphorus elements, adding seed crystal, aging under heating and stirring, filtering the aged solution to obtain a filter residue, and drying and sintering the filter residue, thereby obtaining the ferric phosphate, wherein the seed crystal is ferric phosphate dihydrate or basic ammonium ferric phosphate.

In some embodiments of the present invention, a method for preparing the seed crystal is as follows: adding a first alkaline solution to a second metal liquid containing iron and phosphorus elements, adjusting a pH value of the solution, and performing crystal transformation and aging of the solution under heating and stirring, thereby obtaining the seed crystal. Preferably, a molar ratio of iron to phosphorus in the second metal liquid is 1:1.10 to 1:1.50.

In some embodiments of the present invention, the first metal liquid and/or the second metal liquid is the filtrate obtained by the acid dissolution and the filtration of waste ferric phosphate. Preferably, the waste ferric phosphate is at least one of anhydrous ferric phosphate, ferric phosphate dihydrate, amorphous ferric phosphate, and residue of waste lithium iron phosphate cathode powder after lithium extraction. Using a recycled waste ferric phosphate as a raw material recycles waste resources at a low cost, not only achieving economic benefits for the companies but also protecting the environment.

In some embodiments of the present invention, on the condition that the waste ferric phosphate is ferric phosphate dihydrate, the acid dissolution is performed after a baking process, and the baking process is performed at a temperature of 250° C. to 450° C. for 1 hour (h) to 5 h. Further, the baking process is performed at a temperature of 300° C. to 400° C. for 2 h to 4 h. The baking process is to dehydrate ferric phosphate dihydrate into anhydrous ferric phosphate so as to dissolve the ferric phosphate in the acid solution.

In some embodiments of the present invention, the acid solution used in the acid dissolution is at least one of sulfuric acid, hydrochloric acid, and phosphoric acid, with a concentration of 0.8 mol/L to 3 mol/L. Further, the acid solution is sulfuric acid with a concentration of 1.2 mol/L to 2.0 mol/L. Further, a mass concentration of phosphoric acid is 80% to 90%, more preferably 85%.

In some embodiments of the present invention, the acid dissolution is performed at a temperature of 25° C. to 90° C. for 1 h to 10 h. Further, the acid dissolution is performed at a temperature of 40° C. to 70° C. for 2 h to 5 h.

In some embodiments of the present invention, a molar ratio of iron to phosphorus in the first metal liquid is 1:1.10 to 1:1.50, preferably 1:1.15 to 1:1.30.

In some embodiments of the present invention, the stirring is performed at a speed of 150 rpm to 450 rpm, preferably 200 rpm to 350 rpm.

In some embodiments of the present invention, the heating is performed at a temperature of 60° C. to 95° C.

In some embodiments of the present invention, the aging is performed for 1 h to 10 h, preferably 2 h to 5 h.

In some embodiments of the present invention, the method further comprises a process of adding a second alkaline solution to adjust a pH value of the solution after adding the seed crystal, wherein the pH value of the solution is adjusted to 0.5 to 4, preferably 2 to 3.

In some embodiments of the present invention, the second alkaline solution is a water solution of at least one of ammonium bicarbonate, ammonium carbonate, ammonium chloride, aqueous ammonia, ammonium dihydrogen phosphate, and diammonium hydrogen phosphate. Preferably, the second alkaline solution is a water solution of ammonium chloride or aqueous ammonia.

In some embodiments of the present invention, in preparing the seed crystal, the pH value of the solution is adjusted to 1.5 to 3.5, preferably 1.5 to 2.5.

In some embodiments of the present invention, the first alkaline solution is a water solution of at least one of sodium hydroxide, potassium hydroxide, sodium bicarbonate, ammonium bicarbonate, sodium carbonate, aqueous ammonia, and potassium carbonate. Preferably, a mass concentration of the first alkaline solution is 10% to 30%. More preferably, the first alkaline solution is a water solution of sodium hydroxide or aqueous ammonia with a concentration of 20% to 25%.

In some embodiments of the present invention, the surfactant is at least one of cetyltrimethylammonium bromide, sodium dodecylbenzene sulfonate, sodium dodecyl sulfonate, and polyvinylpyrrolidone. Further, a mass of the surfactant is 0.1% to 2% of a mass of iron in the first metal liquid.

In some preferred embodiments of the present invention, the surfactant is one of cetyltrimethylammonium bromide, sodium dodecyl sulfonate, and polyvinylpyrrolidone. Further, the mass of the surfactant is 0.5% to 1% of the mass of iron in the first metal liquid.

In some embodiments of the present invention, the drying is performed at a temperature of 90° C. to 190° C. for 6 h to 24 h. Further, the drying is performed at a temperature of 100° C. to 140° C. for 12 h to 15 h.

In some embodiments of the present invention, the method comprises a process of water washing the filter residue before the drying, and the water washing is performed until the electrical conductivity of the used water is 500 S/cm or less. Preferably, the water washing is performed until the electrical conductivity of the used water is 200 S/cm or less.

In some embodiments of the present invention, the sintering is performed in an atmosphere of one or more of air, nitrogen gas, and argon gas. A temperature increasing rate of the sintering is 2° C./min to 15° C./min. and the sintering is performed at 200° C. to 350° C. for 1 h to 3 h, followed by 500° C. to 650° C. for 2 h to 6 h.

In some preferred embodiments of the present invention, the method comprises the following steps:
(1) baking waste ferric phosphate, and then adding an acid solution for acid dissolution, followed by filtration to obtain a filtrate that is the metal liquid containing iron and phosphorus, and measuring the contents of iron and phosphorus in the metal liquid;
(2) adding the metal liquid to a first reaction kettle as a bottom liquid, co-flowing the metal liquid and a first alkaline solution into the first reaction kettle while stirring the solution in the first reaction kettle, adjusting a pH value of the mixed solution, and supplementing phosphorus or iron according to the contents of iron and phosphorus in the metal liquid and a total volume of the metal liquid, heating the solution for crystal transformation and aging, thereby obtaining slurry containing seed crystal;
(3) adding a surfactant to a second reaction kettle containing the metal liquid, pumping the slurry containing the seed crystal to the second reaction kettle, co-flowing the slurry containing the seed crystal and a second alkaline solution into the second reaction kettle while stirring the solution in the second reaction kettle;
(4) controlling a pH value of the solution in the second reaction kettle after the slurry containing the seed crystal is completely added, heating for aging, washing, and filtering the solution to obtain a filter residue, and drying the filter residue; and
(5) sintering the powdery filter residue obtained by the drying process in step (4), thereby obtaining the ferric phosphate.

In some embodiments of the present invention, a volume of the first reaction kettle is 50 L to 500 L, preferably 300 L to 500 L.

In some embodiments of the present invention, in step (2) and step (3), blades used in the stirring is selected from the four-blade screw type blades, the four-straight-blade open-turbine type blades, the six-pitched-blade open-turbine type blades, the six-straight-blade disc-turbine type blades, or the six-pitched-blade disc-turbine type blades. Further, the blades is selected from the four-straight-blade open-turbine type blades or the six-straight-blade disc-turbine type blades.

In some embodiments of the present invention, in step (2), a volume of the bottom liquid is 1/5 to 1/3, preferably 1/5, of the volume of the first reaction kettle.

In some embodiments of the present invention, in step (2), a ratio of the feeding speed of the metal liquid to the feeding speed of the first alkaline solution is 10:1 to 3:1, preferably 10:1 to 8:1.

In some embodiments of the present invention, in step (2), the heating temperature is 70° C. to 95° C., and the aging time is 3 h to 10 h. Further, the heating temperature is 80° C. to 95° C., and the aging time is 3 h to 5 h.

In some embodiments of the present invention, in step (3), a volume of the second reaction kettle is 500 L to 1000 L, preferably 1000 L to 5000 L.

In some embodiments of the present invention, in step (3), the metal liquid in the second reaction kettle is 50% to 90%, preferably 60% to 80%, of the volume of the second reaction kettle.

In some embodiments of the present invention, in step (3), a ratio of the feeding speed of the second alkaline solution to the feeding speed of the slurry containing the seed crystal is (0 to 1):(1.5 to 3.5), preferably (0 to 0.5):(1.5 to 2.5).

In some embodiments of the present invention, the powdery filter residue obtained by the drying process in step (4) is ferric phosphate dihydrate or basic ammonium ferric phosphate.

In some embodiments of the present invention, in step (4), the heating temperature is 60° C. to 95° C., and the aging time is 1 h to 6 h. Further, the heating temperature is 80° C. to 95° C., and the aging time is 2 h to 4 h.

The present invention also provides ferric phosphate prepared by the above-described method. The ferric phosphate has a median particle diameter (D50) of 2 m to m, preferably 5 m to 10 m, a tap density of 0.80 g/cm³ to 1.50 g/cm³, a specific surface area of 1 m²/g to 10 m²/g, and an impurity content≤200 ppm.

The present invention also provides use of the ferric phosphate in preparation of batteries, ceramics, or catalysts.

According to a preferred embodiment of the present invention, at least following beneficial effects are achieved:

1. In the present invention, by adding a small amount of pre-synthesized ferric phosphate dihydrate or basic ammonium ferric phosphate as seed crystal into the total reaction system of ferric phosphate, the seed crystal can reduce the thermodynamic barrier for crystal nucleation in the reaction system. Thus, a pure phase of ferric phosphate dihydrate or basic ammonium ferric phosphate can be formed without adding an alkaline solution, accelerating the formation of a well-crystallized product, decreasing the time for synthesing ferric phosphate dihydrate or basic ammonium ferric phosphate, and avoiding forming multiple morphology forms of ferric phosphate when no seed crystal is added. The driving force for the crystallization of the ferric phosphate in the present invention is the seed crystal rather than phosphoric acid which drives amorphous product to crystallize in the conventional aging process. The formed product is highly consistent in morphology and particle size.

2. In the present invention, the surfactant is used for modification of the seed crystal to improve the surface activity of the seed crystal. Then by inducing the epitaxial growth of Fe³⁺ and PO₄³⁻ on the surface of the seed crystal, secondary crystal nuclei are generated, which induces the formation of the basic framework of the product particles. Through the aging process, the deposition of the crystal nuclei on the surface of the seed crystal makes the framework of the crystal grain more complete, so that the primary particles are arranged more densely and orderly and tend to constitute spherical secondary particles. The finally formed anhydrous ferric phosphate has a particle size D50 of about 2 μm to 30 μm, the particles are controllable and easy to wash, and has less moisture and is easy to dry. The secondary particles have uniform morphology and greater tap density, and is suitable for preparation of high-compactness lithium iron phosphate batteries.

3. The equipment required by the present invention is simple and easy to operate. The production process does not require multiple times of wash, resulting in less waste water and lower water treatment costs. With such ferric phosphate prepared by the semi-continuous method, the poor consistency of different batches of product is solved, and the batch stability of the products is guaranteed.

4. In the present invention, ferric phosphate dihydrate and basic ammonium ferric phosphate can be selectively prepared, which is then sintered to obtain anhydrous ferric phosphate. This process requires less consumption of phosphoric acid and alkaline solution, and thus has a low cost compared with the sheer intermittence alkaline precipitation method.

### BRIEF DESCRIPTION OF THE DRAWINGS

The present invention will be further described below in conjunction with the accompanying drawings and embodiments.

FIG. 1 is a flow chart of a method in Example 2 of the present invention.

FIG. 2 is a schematic view of a microcosmic reaction process in Example 1 of the present invention.

FIG. 3 is a X-ray diffraction (XRD) image of ferric phosphate dehydrate formed in Example 1 of the present invention.

FIG. 4 is an scanning electron microscopic (SEM) image of ferric phosphate dehydrate formed in Example 1 of the present invention.

FIG. 5 is a XRD image of anhydrous ferric phosphate formed in Example 1 of the present invention.

FIG. 6 is an SEM image of anhydrous ferric phosphate formed in Example 1 of the present invention.

FIG. 7 is a diagram showing charge-discharge curves at 0.1 C of lithium iron phosphate formed from anhydrous ferric phosphate in Example 1 of the present invention.

### DETAILED DESCRIPTION OF THE EMBODIMENTS

The technical solutions and effects thereof will be clearly and fully described in the embodiments of the present invention in order to make the objects, technical features, and advantages of the present application more clear. Apparently, the described embodiments are merely a part rather than all of the embodiments of the present invention. Based on the embodiments of the present invention, other embodiments obtained by a person of ordinary skill in the art based on the embodiments of the present invention without creative efforts shall fall within the protection scope of the present invention.

### Example 1

In this example, ferric phosphate was prepared according to the process as follows:

(1) 100 kg of waste ferric phosphate dihydrate was baked at 300° C. for 4 h to remove crystal water, leaving about 80 kg of baked material. 80 kg of the baked material was added into a kettle containing 666 L of 1.2 mol/L sulfuric acid solution and stirred at 300 rpm, heated to 60° C. for dissolution for about 6 h, and allowed to stand. After using a precise filter to filter out the filter residue, the obtained filtrate, which was a metal liquid A containing Fe³⁺ and PO₄³−, was transferred to a storage tank. Concentrations of Fe and P elements in the metal liquid A were 40.51 g/L and 22.96 g/L, respectively. A molar ratio of Fe to P in the metal liquid A was 1:1.022.

(2) 20 L of the metal liquid A was injected into a 100 L reaction kettle P1 as the bottom liquid, and stirred at 300 rpm. The metal liquid A and a NaOH solution were co-flowed into the reaction kettle P1 at feeding speeds of 50 L/h and 7.5 L/h respectively. Through a pH value real-time feedback system, the feeding speed of the NaOH solution was finely tuned. The temperature of the reaction kettle P1 was set to 40° C. At the end of the co-flowing step, the pH value of the solution in the reaction kettle P1 was adjusted to 1.8 to precipitate amorphous ferric phosphate. The total metal liquid A in the reaction kettle P1 was 80 L (including the bottom liquid A and the co-flowed metal liquid A). 0.435 L of phosphoric acid was added to the reaction kettle P1 until a molar ratio of Fe to P was equal to 1:1.20, thereby obtaining slurry B. The slurry B was heated to 93° C., kept at this temperature for 2.5 h for crystal transformation, and aged for 5 h, thereby obtaining slurry C. The content of residual Fe in the filtrate when the slurry C was filtered out was 35 mg/L.

(3) 600 L of the metal liquid A was injected into a reaction kettle P2 with a volume of 1 m³. Under stirring at 250 rpm, 24 g of polyvinylpyrrolidone was added as a surfactant, and the slurry C was pumped from the reaction kettle P1 into the reaction kettle P2 at a speed of 100 L/h.

(4) After the ferric phosphate dihydrate slurry C was completely added, a pH value of the solution in the reaction kettle P2 was 0.8. The reaction kettle P2 was heated to 85° C. followed by aging for 3 h. The resultant was washed with water and filtered until the electrical conductivity of the used water was lower than 400 S/cm. The filter residue was collected to obtain a ferric phosphate dihydrate filter cake D, which was dried at 100° C. for 15 h, thereby obtaining ferric phosphate dihydrate powder E.

(5) The dried ferric phosphate dihydrate powder E was put in a muffle furnace, the temperature of which was increased at 10° C./min to 350° C., and kept for 3 h at this temperature, and then increased at 10° C./min to 550° C., and sintered for 3 h at this temperature, and then naturally cooled to room temperature, thereby obtaining the qualified anhydrous FePO₄. Finally, the obtained product was subjected to phase and performance test and analysis. The content of impurity in the anhydrous ferric phosphate was 0.0057 wt %.

The physical and chemical features of the ferric phosphate dihydrate and anhydrous ferric phosphate obtained in this example were shown in Table 1.

TABLE 1
Physical and chemical features of ferric phosphate dihydrate and anhydrous ferric phosphate

| Ferric | Fe(wt %) | P(wt %) | Fe/P | D10(μm) | D50(μm) | D90(μm) | (D90 − D10)/D50 |
|---|---|---|---|---|---|---|---|
| phosphate | 29.01 | 16.46 | 0.977 | 4.43 | 6.88 | 10.7 | 0.911 |
| dihydrate | BET(m²/g) | TD(g/cc) | Ni(wt %) | Co(wt %) | Mn(wt %) | Ca(wt %) | Mg(wt %) |
| | 21.4 | 1.08 | 0.0009 | 0.0002 | 0.0005 | 0.0002 | 0.0001 |
| | Na(wt %) | Cu(wt %) | Zn(wt %) | S(wt %) | Al(wt %) | Ti(wt %) | Mo(wt %) |
| | 0.0018 | 0.0001 | 0.0001 | 0.0055 | 0.0001 | 0.0009 | 0.0001 |
| Anhydrous | Fe(wt %) | P(wt %) | Fe/P | D10(μm) | D50(μm) | D90(μm) | (D90 − D10)/D50 |
| ferric | 36.36 | 20.61 | 0.978 | 4.35 | 6.95 | 11.54 | 1.035 |
| phosphate | BET(m²/g) | TD(g/cc) | Ni(wt %) | Co(wt %) | Mn(wt %) | Ca(wt %) | Mg(wt %) |
| | 5.41 | 1.19 | 0.0012 | 0.0001 | 0.0001 | 0.0001 | 0.0003 |
| | Na(wt %) | Cu(wt %) | Zn(wt %) | S(wt %) | Al(wt %) | Ti(wt %) | Mo(wt %) |
| | 0.0015 | 0.0001 | 0.0001 | 0.0005 | 0.0001 | 0.0015 | 0.0001 |

Table 1 shows that the contents of iron and phosphorus and the contents of other elements in ferric phosphate dihydrate and anhydrous ferric phosphate meet China standards for ferric phosphate. The dispersion of the particle size distribution is small, the particle size distribution is narrow, the tap densities before and after sintering are both high, and the values of the specific surface area are moderate. Therefore, the ferric phosphate product is suitable for being used as a precursor material for the preparation of high-compactness lithium iron phosphate.

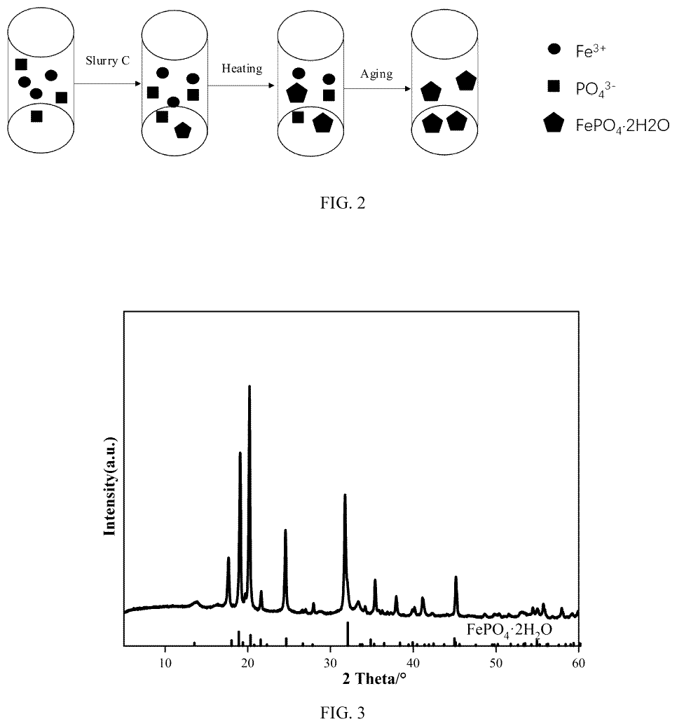

By adding a small amount of ferric phosphate dihydrate pre-synthesized in the reaction kettle P1 as seed crystal into the reaction kettle P2 with the second reaction system, the ferric phosphate dihydrate can reduce the thermodynamic barrier for crystal nucleation in the reaction system. In the reaction kettle P2, a pure phase of ferric phosphate dihydrate is obtained without adding an alkaline solution, accelerating the formation of a well-crystallized product, decreasing the time for synthesing ferric phosphate dihydrate, and avoiding forming multiple morphology forms of ferric phosphate when no seed crystal is added. The function of the seed crystal is to provide crystal nuclei and induce crystallization. The crystallization process is performed according to the route shown in FIG. 2. The driving force for the crystallization of the ferric phosphate is the seed crystal rather than phosphoric acid which drives amorphous product to crystallize in the conventional aging process. The formed product has highly consistent morphology and particle size. The surfactant in the reaction kettle is used for modification of the seed crystal to improve the surface activity of the seed crystal. Then by inducing the epitaxial growth of Fe³⁺ and PO₄³⁻ on the surface of the seed crystal, secondary crystal nuclei are generated, which induces the formation of the basic framework of the product particles. Through the aging process, the deposition of the crystal nuclei on the surface of the seed crystal makes the framework of the crystal grain more complete, so that the primary particles are arranged more densely and orderly and tend to constitute spherical secondary particles. During the epitaxial growth process, the primary particles always grow along the shearing force direction due to the shearing effect of the tangential flows created by the stirrer, and thus form a sheet-shaped structure. Compared with the method using the alkaline solution for precipitation and using the phosphoric acid for aging, the present method does not requires a high pH value, so that the preparation can be carried out under strongly acidic condition. No phosphoric acid solution is required to provide the driving force for crystallization, reducing the time for transformation from amorphous to crystalline state, and thus only a short time of aging is needed to make the crystal form more complete and the precipitation more thorough, so that the alkaline solution is less consumed and the yield is high.

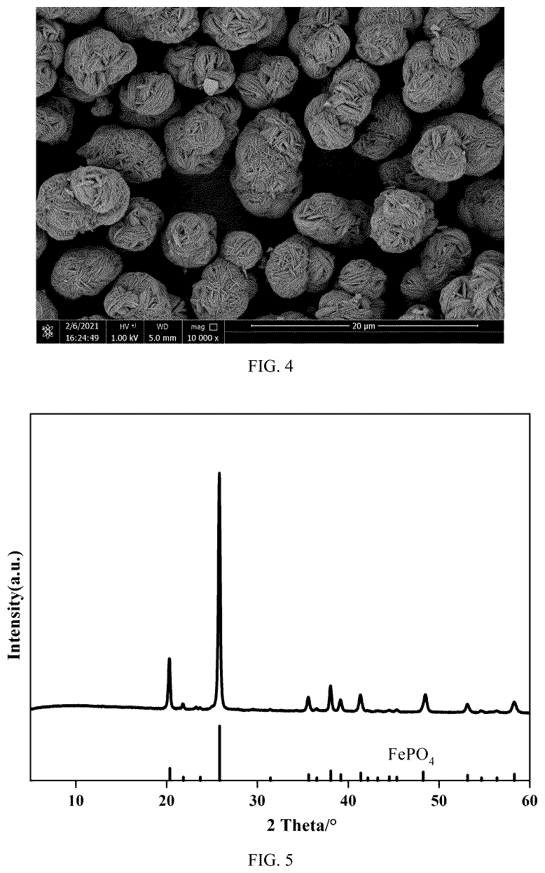

FIG. 3 and FIG. 4 show XRD pattern and SEM image of the ferric phosphate dihydrate prepared in Example 1, respectively. It can be seen from FIG. 3 that the ferric phosphate dihydrate prepared in Example 1 has relatively high purity, good crystallinity with no impurity phases found. It can be seen from FIG. 4 that the prepared ferric phosphate dihydrate particles have uniform particle size distribution, good secondary particle consistency, and good particle dispersion.

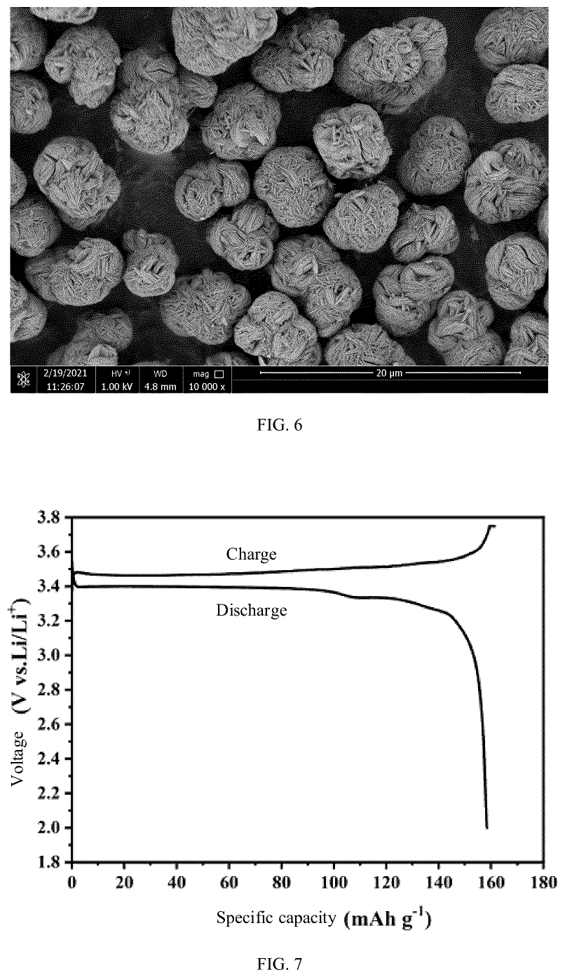

FIG. 5 and FIG. 6 show XRD pattern and SEM image of the anhydrous ferric phosphate prepared in Example 1, respectively. It can be seen from FIG. 5 that the anhydrous ferric phosphate prepared in Example 1 has relatively high purity, good crystallinity with no impurity phases found. It can be seen from FIG. 6 that the prepared anhydrous ferric phosphate particles have uniform particle size distribution, good secondary particle consistency, and good particle dispersion.

FIG. 7 is a graph showing the charge and discharge curves at 0.1C of lithium iron phosphate synthesized from the anhydrous ferric phosphate precursor in Example 1. It can be seen that the lithium iron phosphate prepared using the anhydrous ferric phosphate in Example 1 as the precursor has initial charge and discharge capacities of 161.4 mAh/g and 158.4 mAh/g, respectively, showing electrochemical performance similar to those of commercially available products.

### Example 2

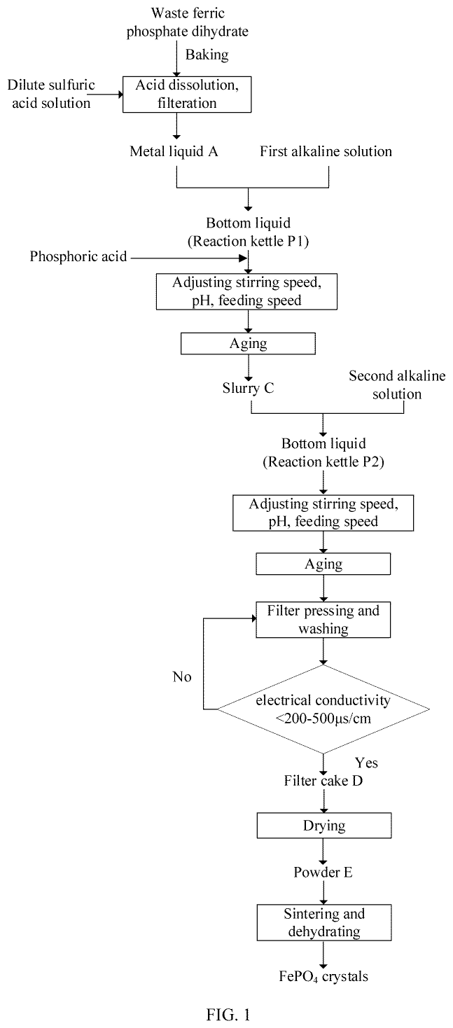

In this example, referring to FIG. 1, ferric phosphate was prepared according to the process as follows:

(1) 100 kg of waste ferric phosphate dihydrate was baked at 400° C. for 3 h to remove crystal water, leaving about 80 kg of baked material. 72 kg of the baked material was added into a kettle containing 600 L of 1.2 mol/L sulfuric acid solution and stirred at 200 rpm, heated to 45° C. for dissolution for about 8 h, and allowed to stand. After using a precise filter to filter out the filter residue, the obtained filtrate, which was a metal liquid A, was transferred to a storage tank. Concentrations of Fe and P elements in the metal liquid A were 42.51 g/L and 24.35 g/L, respectively. A molar ratio of Fe to P in the metal liquid A was 1:1.033.

(2) 10 L of the metal liquid A was injected into a 50 L reaction kettle P1 as the bottom liquid, and stirred at 350 rpm. The metal liquid A and a NaOH solution were co-flowed into the reaction kettle P1 at feeding speeds of 40 L/h and 6 L/h respectively. Through a pH value real-time feedback system, the feeding speed of the NaOH solution was finely tuned. The temperature of the reaction kettle P1 was set to 45° C. At the end of the co-flowing step, the pH value of the solution in the reaction kettle P1 was adjusted to 2.1 to precipitate amorphous ferric phosphate. The total metal liquid A in the reaction kettle P1 was 45 L (including the bottom liquid A and the co-flowed metal liquid A). 0.687 L of phosphoric acid was added to the reaction kettle P1 until a molar ratio of Fe to P was equal to 1:1.30, thereby obtaining slurry B of ferric phosphate dihydrate. The slurry B was heated to 90° C., kept at this temperature for 3 h for crystal transformation, and aged for 3 h, thereby obtaining slurry C of ferric phosphate dihydrate. The content of residual Fe in the filtrate when the slurry C was filtered out was 1.05 mg/L.

(3) 400 L of the metal liquid A was injected into a reaction kettle P2 with a volume of 0.5 m³. Under stirring at 300 rpm, 85 g of sodium dodecyl sulfonate was added as a surfactant, and the slurry C of ferric phosphate dihydrate was pumped from the reaction kettle P1 into the reaction kettle P2 at a speed of 100 L/h. A feeding speed of the second alkaline solution was 10 L/h.

(4) After the ferric phosphate dihydrate slurry C was completely added, a pH value of the solution in the reaction kettle P2 was 3. The reaction kettle P2 was heated to 85° C. followed by aging for 3 h. The resultant was washed with water and filtered until the electrical conductivity of the used water was lower than 500 S/cm. The filter residue was collected to obtain a filter cake D, which was dried at 120° C. for 12 h, thereby obtaining basic ammonium ferric phosphate powder E.

(5) The dried basic ammonium ferric phosphate powder E was put in a muffle furnace, the temperature of which was increased at 10° C./min to 400° C., and kept for 2 h at this temperature, and then increased at 5° C./min to 600° C., and sintered for 2 h at this temperature, and then naturally cooled to room temperature, thereby obtaining the qualified anhydrous FePO₄. Finally, the obtained product was subjected to phase and performance test and analysis. The content of impurity in the ferric phosphate was 0.0152 wt %.

The physical and chemical features of the f basic ammonium ferric phosphate and anhydrous ferric phosphate obtained in this example were shown in Table 2.

TABLE 2
Physical and chemical features of basic ammonium ferric phosphate and anhydrous ferric phosphate

| Basic | Fe(wt %) | P(wt %) | Fe/P | D10(μm) | D50(μm) | D90(μm) | (D90 − D10)/D50 |
|---|---|---|---|---|---|---|---|
| ammonium | 29.21 | 16.66 | 0.972 | 5.35 | 7.56 | 11.3 | 0.787 |
| ferric | BET(m²/g) | TD(g/cc) | Ni(wt %) | Co(wt %) | Mn(wt %) | Ca(wt %) | Mg(wt %) |
| phosphate | 19.57 | 1.35 | 0.0011 | 0.0001 | 0.0012 | 0.0001 | 0.0001 |
| | Na(wt %) | Cu(wt %) | Zn(wt %) | S(wt %) | Al(wt %) | Ti(wt %) | Mo(wt %) |
| | 0.0036 | 0.0011 | 0.0001 | 0.0359 | 0.0001 | 0.0015 | 0.0001 |
| Anhydrous | Fe(wt %) | P(wt %) | Fe/P | D10(μm) | D50(μm) | D90(μm) | (D90 − D10)/D50 |
| ferric | 36.36 | 20.63 | 0.977 | 15.01 | 19.66 | 28.11 | 0.661 |
| phosphate | BET(m²/g) | TD(g/cc) | Ni(wt %) | Co(wt %) | Mn(wt %) | Ca(wt %) | Mg(wt %) |
| | 2.31 | 1.40 | 0.0006 | 0.0001 | 0.0009 | 0.0001 | 0.0002 |
| | Na(wt %) | Cu(wt %) | Zn(wt %) | S(wt %) | Al(wt %) | Ti(wt %) | Mo(wt %) |
| | 0.0045 | 0.0009 | 0.0001 | 0.0055 | 0.0001 | 0.0021 | 0.0001 |

In Example 2, by adding a small amount of ferric phosphate dihydrate pre-synthesized in the reaction kettle P1 as seed crystal into the reaction kettle P2, supersaturated ferric phosphate dihydrate can reduce the thermodynamic barrier for crystal nucleation, inducing NH₄⁺, Fe³⁺ and PO₄³⁻ to grow epitaxially on the surface of the seed crystal, thereby growing a new basic iron ammonium phosphate secondary crystal nucleus on the surface of the seed crystal, accelerating the formation of new crystal nuclei with good crystallinity. No excessive phosphoric acid needs to be added for aging, reducing the amount of phosphoric acid used, shortening the aging time, and reducing energy consumption. It can be seen from Table 2 that basic ammonium ferric phosphate prepared in Example 2 has relatively high purity and relatively good particle dispersion. After being sintered, the anhydrous ferric phosphate has good crystallinity. The contents of iron and phosphorus and the contents of other elements in the basic ammonium ferric phosphate and anhydrous ferric phosphate meet China standards for ferric phosphate. The anhydrous ferric phosphate has a tap density of 1.40 g/cm³ and a specific surface area of 2.31 m²/g. Therefore, the ferric phosphate product is suitable for being used as a precursor material for the preparation of high-compactness lithium iron phosphate.

### Example 3

In this example, ferric phosphate was prepared according to the process as follows:

(1) 100 kg of waste ferric phosphate dihydrate was baked at 300° C. for 3 h to remove crystal water, leaving about 80 kg of baked material. 72 kg of the baked material was added into a kettle containing 600 L of 1.2 mol/L sulfuric acid solution and stirred at 250 rpm, heated to 60° C. for dissolution for about 2 h, and allowed to stand. After using a precise filter to filter out the filter residue, the obtained filtrate, which was a metal liquid A, was transferred to a storage tank. Concentrations of Fe and P elements in the metal liquid A were 42.01 g/L and 24.10 g/L, respectively. A molar ratio of Fe to P in the metal liquid A was 1:1.035.

(2) 20 L of the metal liquid A was injected into a 100 L reaction kettle P1 as the bottom liquid, and stirred at 250 rpm. The metal liquid A and aqueous ammonia were co-flowed into the reaction kettle P1 at feeding speeds of 40 L/h and 6 L/h respectively. Through a pH value real-time feedback system, the feeding speed of the aqueous ammonia was finely tuned. The temperature of the reaction kettle P1 was set to 40° C. At the end of the co-flowing step, the pH value of the solution in the reaction kettle P1 was adjusted to 2.1 to precipitate amorphous ferric phosphate. The total metal liquid A in the reaction kettle P1 was 45 L (including the bottom liquid A and the co-flowed metal liquid A). 0.68 L of phosphoric acid was added to the reaction kettle P1 until a molar ratio of Fe to P was equal to 1:1.30, thereby obtaining slurry B. The slurry B was heated to 90° C., kept at this temperature for 3 h for crystal transformation, and aged for 3 h, thereby obtaining slurry C of basic ammonium ferric phosphate. The content of residual Fe in the filtrate when the slurry C was filtered out was 1.05 mg/L.

(3) 400 L of the metal liquid A was injected into a reaction kettle P2 with a volume of 0.5 m³. Under stirring at 300 rpm, 85 g of sodium dodecyl sulfonate was added as a surfactant, and the slurry C of basic ammonium ferric phosphate was pumped from the reaction kettle P1 into the reaction kettle P2 at a speed of 100 L/h.

(4) After the basic ammonium ferric phosphate slurry C was completely added, a pH value of the solution in the reaction kettle P2 was 0.95. The reaction kettle P2 was heated to 85° C. followed by aging for 3 h. The resultant was washed with water and filtered until the electrical conductivity of the used water was lower than 500 S/cm. The filter residue was collected to obtain a ferric phosphate dihydrate filter cake D, which was dried at 120° C. for 12 h, thereby obtaining ferric phosphate dihydrate powder E.

(5) The dried ferric phosphate dihydrate powder E was put in a muffle furnace, the temperature of which was increased at 10° C./min to 400° C., and kept for 1 h at this temperature, and then increased at 5° C./min to 550° C., and sintered for 2 h at this temperature, and then naturally cooled to room temperature, thereby obtaining the qualified anhydrous FePO₄. Finally, the obtained product was subjected to phase and performance test and analysis. The content of impurity in the anhydrous ferric phosphate was 0.0042 wt %.

The physical and chemical features of the ferric phosphate dihydrate and anhydrous ferric phosphate obtained in this example were shown in Table 3.

TABLE 3
Physical and chemical features of ferric phosphate dihydrate and anhydrous ferric phosphate

| Ferric | Fe(wt %) | P(wt %) | Fe/P | D10(μm) | D50(μm) | D90(μm) | (D90 − D10)/D50 |
|---|---|---|---|---|---|---|---|
| phosphate | 29.12 | 16.54 | 0.976 | 6.58 | 9.86 | 15.44 | 0.899 |
| dihydrate | BET(m²/g) | TD(g/cc) | Ni(wt %) | Co(wt %) | Mn(wt %) | Ca(wt %) | Mg(wt %) |
| | 25.31 | 1.13 | 0.0001 | 0.0004 | 0.0002 | 0.0001 | 0.0002 |
| | Na(wt %) | Cu(wt %) | Zn(wt %) | S(wt %) | Al(wt %) | Ti(wt %) | Mo(wt %) |
| | 0.0006 | 0.0001 | 0.0001 | 0.0125 | 0.0008 | 0.0001 | 0.0005 |
| Anhydrous | Fe(wt %) | P(wt %) | Fe/P | D10(μm) | D50(μm) | D90(μm) | (D90 − D10)/D50 |
| ferric | 36.25 | 20.63 | 0.974 | 10.41 | 16.01 | 25.23 | 0.926 |
| phosphate | BET(m²/g) | TD(g/cc) | Ni(wt %) | Co(wt %) | Mn(wt %) | Ca(wt %) | Mg(wt %) |
| | 4.05 | 1.21 | 0.0004 | 0.0001 | 0.0001 | 0.0002 | 0.0002 |
| | Na(wt %) | Cu(wt %) | Zn(wt %) | S(wt %) | Al(wt %) | Ti(wt %) | Mo(wt %) |
| | 0.0021 | 0.0001 | 0.0002 | 0.0004 | 0.0001 | 0.0001 | 0.0002 |

In Example 3, by adding a small amount of basic ammonium ferric phosphate pre-synthesized in the reaction kettle P1 as seed crystal into the reaction kettle P2 with the second reaction system, supersaturated basic ammonium ferric phosphate can reduce the thermodynamic barrier of crystal nucleation, inducing Fe³⁺ and PO₄³⁻ to grow epitaxially on the surface of the seed crystal. However, as an ammonium-containing alkaline solution is not added as a raw material to increase the pH value in this process, the pH value in the system is too low, and thus NH₄⁺ in the basic ammonium ferric phosphate complex escapes, and the ferric phosphate skeleton structure of the basic ferric phosphate remains stable. Moreover, sodium dodecyl sulfonate is used as a surfactant, and thus the surface activity of the ferric phosphate skeleton structure is improved, thereby generating a new ferric phosphate dihydrate secondary crystal nuclei on the surface of the seed crystal, accelerating the formation of new crystal nuclei with good crystallinity. No excessive phosphoric acid needs to be added for aging, reducing the amount of phosphoric acid used, shortening the aging time, and reducing energy consumption. In the process of synthesizing ferric phosphate dihydrate using basic ammonium ferric phosphate as seed crystal, NH₄⁺ and OH⁻ are dissolved and escaped from the structural unit of basic ammonium ferric phosphate (NH₄Fe₂(OH)(PO₄)₂·nH₂O) but the basic skeleton structure FePO₄·2H₂O is retained in high acidity at the beginning of the addition of basic ammonium ferric phosphate. Therefore, the remained skeleton of basic ammonium ferric phosphate has a porous structure, which induces new nuclei to epitaxially grow on the surface of the seed crystal to form a porous structure, and thus the formed ferric phosphate dihydrate has a porous structure, which is conducive to the migration of lithium ions in the lithium iron phosphate prepared therefrom, so that the prepared lithium iron phosphate has high tap density and high specific capacity. It can be seen from Table 3 that ferric phosphate dihydrate prepared in Example 3 has relatively high purity and relatively good particle dispersion. After being sintered, the anhydrous ferric phosphate has good crystallinity. The contents of iron and phosphorus and the contents of other elements in ferric phosphate dihydrate and anhydrous ferric phosphate meet China standards for ferric phosphate. The anhydrous ferric phosphate has a tap density of 1.21 g/cm³ and a specific surface area of 4.05 m²/g. Therefore, the ferric phosphate product is suitable for being used as a precursor material for the preparation of high-compactness lithium iron phosphate.

### Example 4

In this example, ferric phosphate was prepared according to the process as follows:

(1) 200 kg of residue of waste lithium iron phosphate cathode powder after lithium extraction was baked at 350° C. for 3 h to remove crystal water, leaving about 200 kg of baked material. 200 kg of the baked material was added into a kettle containing 1000 L of 1.5 mol/L sulfuric acid solution and stirred at 400 rpm, heated to 60° C. for dissolution for about 3 h, and allowed to stand. After using a precise filter to filter out the filter residue, the obtained filtrate, which was a metal liquid A, was transferred to a storage tank. Concentrations of Fe and P elements in the metal liquid A were 48.12 g/L and 27.52 g/L, respectively. A molar ratio of Fe to P in the metal liquid A was 1:1.031.

(2) 25 L of the metal liquid A was injected into a 100 L reaction kettle P1 as the bottom liquid, and stirred at 300 rpm. The metal liquid A and a NaOH solution were co-flowed into the reaction kettle P1 at feeding speeds of 100 L/h and 14 L/h respectively. Through a pH value real-time feedback system, the feeding speed of the NaOH solution was finely tuned. The temperature of the reaction kettle P1 was set to room temperature. At the end of the co-flowing step, the pH value of the solution in the reaction kettle P1 was adjusted to 2.5 to precipitate amorphous ferric phosphate. The total metal liquid A in the reaction kettle P1 was 80 L (including the bottom liquid A and the co-flowed metal liquid A). 0.548 L of phosphoric acid was added to the reaction kettle P1 until a molar ratio of Fe to P was equal to 1:1.15, thereby obtaining slurry B of ferric phosphate. The slurry B was heated to 95° C., kept at this temperature for 3.5 h for crystal transformation, and aged for 6 h, thereby obtaining slurry C. The content of residual Fe in the filtrate when the slurry C was filtered out was 0.95 mg/L.

(3) 800 L of the metal liquid A was injected into a reaction kettle P2 with a volume of 1 m³. Under stirring at 250 rpm, 345 g of cetyltrimethylammonium bromide was added as a surfactant, and the slurry C was pumped from the reaction kettle P1 into the reaction kettle P2 at a speed of 100 L/h.

(4) After the slurry C was completely added, a pH value of the solution in the reaction kettle P2 was 0.85. The reaction kettle P2 was heated to 80° C. followed by aging for 4 h. The resultant was washed with water and filtered until the electrical conductivity of the used water was lower than 200 S/cm. The filter residue was collected to obtain a ferric phosphate dihydrate filter cake D, which was dried at 140° C. for 10 h, thereby obtaining ferric phosphate dihydrate powder E.

(5) The dried ferric phosphate dihydrate powder E was put in a muffle furnace, the temperature of which was increased at 5° C./min to 400° C., and kept for 2 h at this temperature, and then increased at 10° C./min to 550° C., and sintered for 3 h at this temperature, and then naturally cooled to room temperature, thereby obtaining the qualified anhydrous FePO₄. Finally, the obtained product was subjected to phase and performance test and analysis. The content of impurity in the anhydrous ferric phosphate was 0.0163 wt %.

The physical and chemical features of the ferric phosphate dihydrate and anhydrous ferric phosphate obtained in this example were shown in Table 4.

TABLE 4
Physical and chemical features of ferric phosphate dihydrate and anhydrous ferric phosphate

| Ferric | Fe(wt %) | P(wt %) | Fe/P | D10(μm) | D50(μm) | D90(μm) | (D90 − D10)/D50 |
|---|---|---|---|---|---|---|---|
| phosphate | 29.04 | 16.39 | 0.983 | 3.10 | 4.57 | 6.67 | 0.781 |
| dihydrate | BET(m²/g) | TD(g/cc) | Ni(wt %) | Co(wt %) | Mn(wt %) | Ca(wt %) | Mg(wt %) |
| | 21.5 | 1.11 | 0.0021 | 0.0017 | 0.0021 | 0.0001 | 0.0012 |
| | Na(wt %) | Cu(wt %) | Zn(wt %) | S(wt %) | Al(wt %) | Ti(wt %) | Mo(wt %) |
| | 0.0047 | 0.0001 | 0.0005 | 0.0132 | 0.0001 | 0.0021 | 0.0001 |
| Anhydrous | Fe(wt %) | P(wt %) | Fe/P | D10(μm) | D50(μm) | D90(μm) | (D90 − D10)/D50 |
| ferric | 36.45 | 20.71 | 0.976 | 3.03 | 4.86 | 7.01 | 0.819 |
| phosphate | BET(m²/g) | TD(g/cc) | Ni(wt %) | Co(wt %) | Mn(wt %) | Ca(wt %) | Mg(wt %) |
| | 4.63 | 1.23 | 0.0013 | 0.0017 | 0.0025 | 0.0002 | 0.0008 |
| | Na(wt %) | Cu(wt %) | Zn(wt %) | S(wt %) | Al(wt %) | Ti(wt %) | Mo(wt %) |
| | 0.0034 | 0.0015 | 0.0013 | 0.0005 | 0.0001 | 0.0029 | 0.0001 |

It can be seen from Table 4 that ferric phosphate dihydrate and anhydrous ferric phosphate prepared in Example 4 have good crystallinity. The contents of iron and phosphorus and the contents of other elements meet China standards for ferric phosphate. The anhydrous ferric phosphate has a tap density of 1.23 g/cm³, and a specific surface area of 4.63 m²/g. Therefore, the ferric phosphate product is suitable for being used as a precursor material for the preparation of high-compactness lithium iron phosphate.

### Test Examples

The ferric phosphate prepared in Examples 1-4 and the commercially available ferric phosphate were prepared into lithium iron phosphate under the same conditions according to a conventional method, and the compacted density and other electrical properties of the prepared lithium iron phosphate were tested. The results were shown in Table 5 below.

TABLE 5

| | | Charge | Discharge | |
|---|---|---|---|---|
| | | specific | specific | |
| | Compacted | capacity at | capacity at | Initial |
| | density | 0.1 C | 0.1 C | efficiency |
| | (g/cm³) | (mAh/g) | (mAh/g) | (%) |
| Example 1 | 2.421 | 161.4 | 158.4 | 98.12 |
| Example 2 | 2.375 | 160.8 | 158.2 | 98.38 |
| Example 3 | 2.388 | 161.3 | 158.5 | 98.26 |
| Example 4 | 2.393 | 161.6 | 158.0 | 97.77 |
| Commercially | 2.382 | 160.1 | 157.2 | 98.19 |
| available | | | | |
| product | | | | |

It can be seen from Table 5 that the compacted density and electrical properties of the lithium iron phosphate powders prepared from the anhydrous ferric phosphate synthesized in Examples 1-4 of the present invention are similar to those of the lithium iron phosphate powder prepared from the commercially available ferric phosphate, indicating that the ferric phosphate synthesized in the present invention reaches the standard of battery-grade anhydrous ferric phosphate for lithium iron phosphate.

The embodiments of the present invention are described in detail above in conjunction to the accompanying drawings. However, the present invention is not limited to the above-mentioned embodiments. Various changes can be made within the scope of knowledge possessed by a person of ordinary skill in the art without departing from the purpose of the present invention. In addition, the embodiments in the present invention and the characteristics in the embodiments can be combined mutually in the case of no conflict.

1. A method for preparing ferric phosphate, comprising:
mixing a surfactant with a first metal liquid containing iron and phosphorus elements;
adding seed crystal;
aging under heating and stirring;
filtering the aged solution to obtain a filter residue; and
drying and sintering the filter residue, thereby obtaining the ferric phosphate, wherein the seed crystal is ferric phosphate dihydrate or basic ammonium ferric phosphate.

2. The method according to claim 1, wherein a method for preparing the seed crystal is as follows:
adding a first alkaline solution to a second metal liquid containing iron and phosphorus elements;
adjusting a pH value of the solution; and
performing crystal transformation and aging of the solution under heating and stirring, thereby obtaining the seed crystal;
preferably, a molar ratio of iron to phosphorus in the second metal liquid is 1:1.10 to 1:1.50.

3. The method according to claim 2, wherein the first metal liquid and/or the second metal liquid is a filtrate obtained by acid dissolution and filtration of the waste ferric phosphate;
preferably, the waste ferric phosphate is at least one of anhydrous ferric phosphate, ferric phosphate dihydrate, amorphous ferric phosphate, or residue of waste lithium iron phosphate cathode powder after lithium extraction.

4. The method according to claim 1, wherein a molar ratio of iron to phosphorus in the first metal liquid is 1:1.10 to 1:1.50.

5. The method according to claim 1, wherein the stirring is performed at a speed of 150 rpm to 450 rpm;
preferably, the heating is performed at a temperature of 60° C. to 95° C.

6. The method according to claim 1, further comprising a process of adding a second alkaline solution to adjust a pH value of the solution after adding the seed crystal, wherein the pH value of the solution is adjusted to 0.5 to 4;
preferably, the second alkaline solution is a water solution of at least one of ammonium bicarbonate, ammonium carbonate, ammonium chloride, aqueous ammonia, ammonium dihydrogen phosphate, and diammonium hydrogen phosphate.

7. The method according to claim 2, wherein the pH value of the solution is adjusted to 1.5 to 3.5;
preferably, the first alkaline solution is a water solution of at least one of sodium hydroxide, potassium hydroxide, sodium bicarbonate, ammonium bicarbonate, sodium carbonate, aqueous ammonia and potassium carbonate.

8. The method according to claim 1, wherein the surfactant is at least one of cetyltrimethylammonium bromide, sodium dodecylbenzene sulfonate, sodium dodecyl sulfonate, and polyvinylpyrrolidone;
preferably, a mass of the surfactant is 0.1% to 2% of a mass of iron in the first metal liquid.

9. A ferric phosphate prepared by the method according to claim 1, the ferric phosphate having a D50 of 2 μm to 30 μm, a tap density of 0.80 g/cm³ to 1.50 g/cm³, a specific surface area of 1 m²/g to 10 m²/g, and an impurity content≤200 ppm.

10. Use of the ferric phosphate according to claim 9 in preparation of batteries, ceramics, or catalysts.

11. The method according to claim 2, wherein the stirring is performed at a speed of 150 rpm to 450 rpm;
preferably, the heating is performed at a temperature of 60° C. to 95° C.
